(19) United States
(12) Patent Application Publication
(10) Pub. No.: US 2012/0282433 A1
(43) Pub. Date: Nov. 8, 2012

(54) PROCESSES TO CLEAN AND RECYCLE CARPET FIBER AND THERMOPLASTICS MADE FROM SUCH PROCESSES

(75) Inventor: Nirmal K. Agarwal, columbia, SC (US)

(73) Assignee: INVISTA North America S.a.r.l, Wilmington, DE (US)

(21) Appl. No.: 13/522,516

(22) PCT Filed: Jan. 17, 2011
(86) PCT No.: PCT/US2011/021482

§ 371 Date: Jul. 17, 2012

Related U.S. Application Data
(60) Provisional application No. 61/295,804, filed on Jan. 18, 2010.

(51) Int. Cl. C08L 77/06; B29C 47/00; B29C 67/02; D06L 1/20; D04H 11/00

(52) U.S. Cl. 428/97; 8/137; 525/420; 264/117; 264/176.1

(57) ABSTRACT

A process for cleaning short segments and bundles of carpet yarn removed from used carpets and converting the cleaned carpet fiber filaments into recycled carpet fiber is disclosed. The process reduces mechanical complexity, saves water, and minimizes the volume of waste when compared to known process. The process comprises turbulent mixing of carpet fiber segments and bundles in an aqueous medium to remove entrained particulates and soluble materials. A thermoplastic pellet or granule, carpet fiber, and carpet made from carpet filaments cleaned with the disclosed process is also provided.

### RELATED APPLICATIONS

This application claims priority to U.S. Provisional Application No. 61/295,804, filed on Jan. 15, 2010, which is herein incorporated by reference in its entirety.

### FIELD OF THE INVENTION

The invention relates to the carpet industry in general, and to the cleaning and recycling of carpets, and in particular, to the recycle of carpet fiber filaments. Processes for the cleaning of carpet yarn segments and bundles that have been shorn from used carpet for the purpose of recycling are disclosed. The processes are applicable to any thermoplastic fiber filaments, such as nylon, polyester, acrylics, and polyolefins. Also disclosed herein are carpet yarns, thermoplastic pellets, and molded articles made from filaments recycled using the disclosed processes.

### BACKGROUND OF THE TECHNOLOGY

Carpets are inherently composite structures with multiple components, including yarn in the carpet pile as well as backing fabric and binding materials. Cushioning materials are also sometimes present. After extended use, carpets usually contain a large amount of particulates and dirt. As a result, many recycling processes now involve cutting the most valuable carpet component, the carpet yarn, away from the backing, in order to isolate it as cost effectively as possible. This creates a lower volume and weight of secondary waste in the form of dry carpet backing, which can then be readily incinerated or otherwise, disposed.

After carpet fiber has been cut, or shorn, from well-used carpet, the recovered fiber still contains particulates and is dirty, and is generally unsuitable for melting and extrusion into new carpet fiber. Instead, it is usually necessary to remove the particulates and soluble materials (e.g. dirt, oil, grease and other contaminants) that are retained by the yarn in the carpet. The particulates have a strong tendency to be trapped and retained in yarn fiber bundles, even after the fiber is removed from the carpet backing and subsequently washed.

U.S. Patent Application Publication No. 2009/0082476A1 discloses a multi-step yarn recovery, cleaning, and extrusion processes. This process incorporates carpet shearing to yield cut yarn segments, followed by screening, yarn size reduction using a mechanical grinder, aqueous washing, drying, extruding, melt-filtering, pelletizing, and spinning into useful fiber. The mechanical screening and grinding steps separate the yarn fiber filaments and remove the particulates, while the aqueous washing step removes the soluble materials and additional particulates.

### BRIEF DESCRIPTION OF THE FIGURES

FIG. 1 is a process flow diagram of one aspect of the disclosed process using commercial paper pulp processing equipment.

### SUMMARY OF THE INVENTION

Cost effective recycling of carpeting is becoming increasingly desirable to the flooring industry world-wide, as the sheer volume of carpet going into landfills is seen to have an increasingly negative impact on society, and the energy invested in carpet becomes less and less affordable. Standards of various kinds now reflect this concern, and carpet fiber with substantial fractions of recycled content are increasingly in demand, especially for public and government installations.

Unfortunately however, the prior art processes have the economic disadvantage of incorporating several expensive process steps, while still trapping contaminants in the polymer matrix. As a result of such contamination, the quality of polymer obtained in melting tends to be less than satisfactory.

Therefore, it is desirable to find a more efficient, low cost process for removing particulates and soluble materials from shorn carpet yarn segments before subjecting them to further recovery processes. Such a low cost and efficient process would be especially beneficial in the case of recovering thermoplastic synthetic polymer yarn segments prior to melting and extrusion. It would also be highly desirable to avoid the introduction of new contaminants and waste streams in the practice of such a process.

The invention disclosed herein provides an economical process to obtain clean carpet yarn filaments from yarn segments and bundles that are shorn from post consumer and industrial (used) carpets. The cleaning process comprises subjecting shorn yarn segments and bundles, which are composed of multiple filaments and even multiple yarn segments that are twisted, intermingled or otherwise entwined, to turbulent mixing in an aqueous medium. The cleaning process foregoes the need for separate mechanical screening and grinding steps to remove particulates. Turbulent mixing individualizes the fiber filaments of short yarn segments and bundles almost completely from each other, releasing the particulates previously bound within the multifilament yarn segments and bundles into the aqueous medium, and removes any remaining soluble materials. The result is cleaned carpet yarn filaments with little or no particulates or soluble materials entrained therein. Also provided is a process of converting the cleaned carpet yarn filaments into recycled thermoplastic pellets and granules. Further provided are carpet fibers, carpets and molded thermoplastic products made from carpet filaments recycled using the disclosed processes.

In one aspect of the disclosed process, carpet fiber filaments are provided to a vessel then separated from entrained particulates and soluble materials by turbulent mixing in an aqueous medium followed by recovering the filaments from the aqueous medium, whereby the aqueous medium contains a substantial majority of the particulates and soluble materials. Optionally, the carpet filaments can be pre-cleaned (e.g. pneumatic separation techniques) prior to turbulent mixing. Turbulent mixing can be any type of high energy agitation, including, homogenizing, high shear mixing, jet mixing, and blending processes that provide sufficiently high shear rates. Turbulent mixing processes will also typically include laminar, transitional, and turbulent flow regions. The filaments can be any synthetic thermoplastic fiber, including nylon, polyesters, acrylics, polyolefins, and biosourced polymers. The aqueous medium can include water, deionized water, polar solvents, non-polar solvents, or surfactants. The yarn filaments can be recovered using various solid/liquid separating devices, including one or more of the following: filter, screen, inclined screw, decanter centrifuge, press, or a moving belt.

In another aspect of the disclosed process, carpet fiber filaments are provided to a vessel then separated from entrained particulates and soluble materials by turbulent mixing in an aqueous medium followed by hydrocycloning to remove heavy particulates from the aqueous medium. The carpet filaments are then recovered from the remaining aqueous medium, whereby the aqueous medium contains a substantial majority of the remaining particulates and soluble materials. Optionally, the carpet filaments can be pre-cleaned (e.g. pneumatic separation techniques) prior to turbulent mixing. Turbulent mixing can be any type of high energy agitation that provides sufficient shear rate, including, homogenizing, high shear mixing, jet mixing, and blending. The filaments can be any synthetic thermoplastic fiber, including nylon, polyesters, acrylics, polyolefins, and biosourced polymers. The aqueous medium can include water, deionized water, polar solvents, non-polar solvents, or surfactants. The yarn filaments can be recovered using various solid/liquid separating devices, including one or more of the following: filter, screen, inclined screw, decantor centrifuge, press, or a moving belt.

In a further aspect, the cleaned carpet yarn filaments are recycled. The recycling can include densifying the filaments into granules or pellets, prior to melting and extrusion in fiber form. The filaments may also be substantially dried prior to conversion into granules or pellets using known filament drying techniques. Densification into pellets can be performed by melting the cleaned carpet yarn filaments and extruding the resulting liquid polymer into strands which are then quenched and cut into pellets by means known in the art. Such pellets are then suitable for later re-melting and extrusion into fiber.

In yet another aspect, a thermoplastic, such as a carpet fiber or molded article, manufactured using the recycled carpet filaments is provided.

In yet a further aspect, a carpet made from a carpet fiber manufactured using the recycled carpet filaments is provided.

In a separate aspect, a thermoplastic pellet or granule is provided, comprising between 5% and 100% by weight post consumer yarn filaments that are substantially free of particulates and soluble materials, and up to 95% of a material selected from the group consisting of: post industrial thermoplastic filaments, post consumer thermoplastic filaments, virgin thermoplastic, and recycled PET.

In another separate aspect, a carpet fiber is provided, comprising between 2.5% and 95% by weight recycled cleaned fiber, wherein said cleaned carpet fiber comprises carpet filaments that are substantially free of particulates and soluble materials; and between 97.5% and 5% by weight of a material selected from the group consisting of: post industrial thermoplastic filaments, post consumer thermoplastic filaments, virgin thermoplastic, and recycled PET.

### DEFINITIONS

While mostly familiar to those versed in the art, the following definitions are provided in the interest of clarity.

Particulates: Solid particles (e.g. sand, sediment, metal, wood, insoluble biological materials, and plastic shavings) that are not readily dissolved in and would form a slurry when mixed in an aqueous medium.

Soluble materials: Materials (e.g. dirt, cleaning mediums, grease, and oil) that are readily dissolved, dispersed, or emulsified in an aqueous medium.

### DETAILED DESCRIPTION OF THE INVENTION

A process for obtaining clean carpet yarn filaments from yarn segments and bundles that are shorn from post consumer (used) carpets is disclosed. The process comprises providing carpet yarn segments and bundles to a vessel, then separating particulates and soluble materials from carpet yarn filaments using turbulent mixing in an aqueous medium, followed by recovering the carpet yarn filaments. Alternatively, the carpet yarn filaments can be subject to hydrocycloning after turbulent mixing and prior to recovering the carpet yarn filaments. The hydrocycloning separates the heavy particulates from the aqueous medium. The cleaning process foregoes the need for separate mechanical screening and grinding steps to remove particulate contaminants. Turbulent mixing individualizes the fiber filaments of short yarn segments and bundles almost completely from each other, releasing the particulates previously bound within the multifilament yarn segments into the aqueous medium, and removes any remaining soluble materials. After recovering the filaments, the aqueous medium can be either cleaned and recycled back into the turbulent mixing step or discarded.

The fibers and filaments can be nylon, including polyadipamide, polycaprolactam, copolymers, and blends thereof; polyester, including polytrimethyleneterephthlate and polyethyleneterephthalate, and blends thereof; acrylics, including polyacrylonitrile; biosourced polymers, including nylon 11 and nylon 6,10; and polyolefin, including polyethylene, polypropylene, copolymers and blends thereof.

The carpet yarn filaments are shorn by shearing the fibers containing the filaments away from the carpet backing. This creates two streams, one being the carpet yarn filaments in short segment and bundled form, and a second stream being the backing material with a certain fraction of the carpet fiber imbedded in it. The latter stream is normally dry, and can be disposed of using various methods, such as incineration for energy recovery.

The yarn segments and bundles that have been shorn from a carpet are typically composed of multiple filaments and even multiple yarn segments that are twisted, intermingled or otherwise entwined, forming a yarn or yarn bundle of multiple yarns, all generally less than a few inches in length. Depending on the mechanism used for cutting, yarn filaments may be bound or even fused together as a result of friction between the carpet pile and the cutter. These bundled structures are generally persistent in recycle processes. They effectively catch and hold particulates and soluble materials and are extremely difficult to clean if allowed to remain intact.

Turbulent mixing with high shear in an aqueous medium is used to separate the particulates and soluble materials from the yarn segments and bundles and clean the yarn filaments. Turbulent mixing can be any type of high energy agitation, including, homogenizing, high shear mixing, jet mixing, and blending where sufficient shear force is provided to effectively separate the fiber bundles and remove entrained particulate and soluble materials. High shear mixing successfully breaks the tightly wound yarn segments and bundles into individual filaments, so that bundle opening, particulate removal, and soluble material removal occurs simultaneously. Separate cleaning agents may be added, but are often unnecessary and are even undesirable where they contribute to foaming or where they require additional water consumption for effective rinsing. Truly turbulent mixing imparts high shear forces on the yarn segments and bundles, which allows them to separate from each other. Nominal shear forces ranging from about 40,000 sec⁻¹ to about 120,000 sec⁻¹, including from about 40,000 sec⁻¹ to about 80,000 sec⁻¹, from about 40,000 sec⁻¹ to about 60,000 sec⁻¹, from about 50,000 sec⁻¹ to about 70,000 sec⁻¹, and from about 60,000 sec⁻¹ to about 80,000 sec⁻¹ will cause the yarn segments and bundles to separate from each other, releasing the entrained particulates and soluble materials.

Turbulent mixing facilitates wetting of the yarn segments or bundles, effectively lubricating the individual yarn filaments and allowing them to slide across and separate from each other. As a result, yarn bundles with filaments normally having high affinity for one another are separated into individual filaments. The individualizing releases entrained particulates, while the agitation removes remaining soluble materials. Thus, the turbulent mixing removes both particulate material and soluble material from the fibers and filaments in a single step. Simple washing (e.g. commercial washing machine), however, does not individualize the filaments of the yarn bundles and fails to separate the entrained particulates from the fibers and filaments. The fibers and filaments cleaned with the disclosed process have an ash content of less than about 0.3%, including less than about 0.2%, less than about 0.15%, and less than about 0.1%.

One type of apparatus that achieves turbulent mixing is a commercial pulper or defibering machine, for example a Tornado® pulper. This type of Tornado® pulper uses a 36 inch diameter rotor rotating at 430 rpm with a rotor-stator clearance of 0.01 inches, which results in a nominal shear rate of 81,000 sec⁻¹ and a rotor tip speed of 20.6 m/sec. The Tornado® pupler can be used in a 2000 gallon batch vessel with a 3000 gallon-per-minute re-circulation rate. Another type of apparatus that achieves turbulent mixing at a much smaller scale is a blender, such as a Sunbeam® Blender/Coffee Mill Model 2774. Further types of larger scale apparatuses that achieve turbulent mixing are Silverson® Homogenizers. The foregoing are just examples of turbulent mixing apparatuses and devices. Examples of other devices that impart turbulent mixing and high shear rates include: homogenizers microfluidizers, impeller mixers, and static mixers.

The aqueous medium can comprise one or more of the following: water, deionized water, polar solvents, non-polar solvents, and non-foaming surfactants. When water is used, the source can be either well or public water. The aqueous medium can also be cleaned and recycled back into the turbulent mixing step, after recovering the carpet yarn filaments.

The yarn filaments can be recovered using various solid/liquid separating devices, including one or more of the following: filter, screen, inclined screw, decanter centrifuge, press, or a moving belt. The clean carpet yarn filaments and aqueous medium are readily separated from each other and the recovered yarn filaments taken can be dried without a subsequent washing step.

After the filaments are removed, aqueous medium that was employed in the turbulent mixing can be recycled back with or without contaminant removal. Alternatively, contaminants are allowed to settle out of the aqueous medium prior to water filtration, recycle and reuse in turbulent mixing. If filtration and recycling is not desired, the aqueous medium can be discarded.

When yarn bundle segments are turbulently mixed with water at a high shear rate, at least 90% of the yarn bundles are separated into individually distinct filaments, resulting in a slurry of filaments, particulates, and soluble materials in water. The filaments can be recovered after the high shear mixing by dewatering the slurry through a filter, screen, inclined screw, decantor centrifuge, press, or a moving belt. Alternatively, the slurry can be passed through a hydrocyclone to separate heavier particulates from the aqueous medium, resulting in a filament-in-water slurry with about 90% of the particulates in the initial mix being removed. The separated filament is subsequently recovered on a filter, screen, inclined screw, decanter centrifuge, press, or a moving belt.

Once cleaned and dried, the carpet filaments can be converted into granule or pellet form for further processing. Granule formation processes include, but are not limited to, use of a Netzsh-Condux Plastocompactor or a California Pellet Mill, melt extrusion, or a combination thereof. Pellet formation processes include melt extrusion processes that involved feeding the material into a melt compounding extruder, using ram or cramming devices as appropriate to improve feeding efficiency, filtering the molten material using an in-line filtration system, followed by formation of strands that are cooled and then pelletized. Underwater pelletizers for certain polymer types can be also be used, removing the need for stranding the reclaimed material. The reclaimed material can then be used to prepare recycled thermoplastic products, such as recycled carpet fibers or molded articles.

Granules or pellets made with cleaned carpet filaments can contain between 5% and 100% by weight cleaned post-consumer carpet filaments and up to 95% by weight post industrial thermoplastic filaments, post consumer thermoplastic filaments, virgin thermoplastic, or recycled PET. The recycled material can include recycled PET and additional carpet filaments, either post-consumer or post-industrial. The cleaned post consumer carpet filaments are substantially free of particulates and soluble materials. Alternatively, the cleaned carpet filaments can be melt-extruded as described above and converted directly into carpet fiber by means known in the art without intervening densification into granules and pellets.

The recycled carpet filaments can be manufactured into recycled carpet fibers or molded thermoplastics using known techniques. The carpet fibers can contain between 2.5% and 95% by weight recycled cleaned fiber, including 2.5%-80% by weight, 20%-80% by weight, 20%-60% by weight, 20%-40% by weight, and 25% by weight recycled cleaned fibers. The recycled carpet fibers can also include post industrial thermoplastic filaments, post consumer thermoplastic filaments, virgin thermoplastic, or recycled PET.

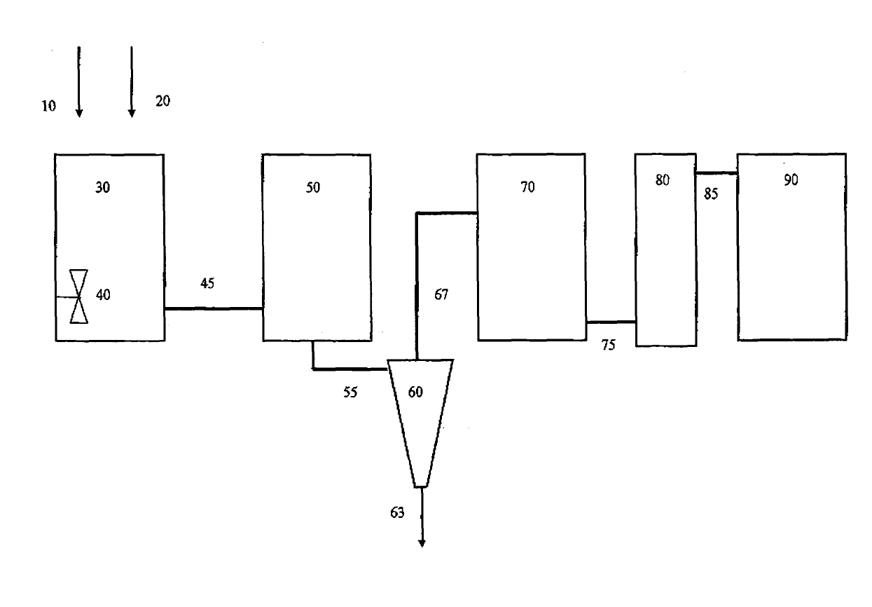

FIG. 1 describes one aspect of the disclosed process using commercial paper pulp processing equipment. The sheered carpet yarn bundle segments 10 and aqueous medium 20 are provided to a vessel 30 with an agitator 40 to provide turbulent mixing. The amount of aqueous medium 20 provided to the vessel 30 is enough to create a 1% to 5% by weight carpet yarn segments 10 in solution of aqueous medium 20. The solution is then turbulently mixed to separate at least 90% of the carpet yarn bundles into individual distinct filaments, and release the particulates and soluble materials. After turbulent mixing, the slurry of carpet yarn filaments, particulates, and soluble materials is pumped or passed to an optional holding tank 50 via conduit 45. The slurry can be diluted down even further in the holding tank to about 0.5% by weight carpet yarn segments prior to providing the slurry to the optional hydrocyclone 60. Alternatively, the slurry may pass through a filter screen (not shown) prior to providing the slurry to the optional holding tank 50. The slurry can be next pumped or passed to an optional hydrocyclone 60 via conduit 55, where the hydrocyclone separates heavier particulates from the aqueous medium. The heavy particulates 63 are discharged from the hydrocyclone, whereas the aqueous medium containing the lighter filaments is passed to an optional holding tank 70 via conduit 67. This filament slurry is than passed to a dewatering device 80 to recover the filaments from a portion of the aqueous medium. The aqueous medium contains a substantial majority of the particulates and soluble materials. The recovered filaments, which are saturated with aqueous medium, are than passed to an optional holding vessel 90. From the optional holding vessel 90, the filaments may be dried or further processed into recycled thermoplastics. Depending on the dewatering device initially used and the amount of aqueous medium in the fiber, a second dewatering device may be employed (not shown). Drying takes place using conventional dryers, such as hot air dryers or belt dryers.

### EXAMPLES

The following are examples of post consumer nylon 6,6 carpet yarn bundles and segments that have been shorn from the carpet backing and cleaned using a prior art method and two aspects of the process disclosed above. The carpet yarn bundles contained various particulate and soluble material contaminants.

Examples 1 and 2 compare the contaminant level of carpet yarn cleaned using a known method verses carpet yarn cleaned using turbulent high shear mixing with water, respectively. Examples 3 and 4 compare the contaminant level of un-cleaned carpet yarn verses carpet yarn cleaned using one aspect of the disclosed process, respectively. Examples 3 and 4 also evaluate properties of carpet yarns made with 25% post consumer and industrial recycled fiber cleaned using one aspect of the disclosed process. Selection of alternative carpets, aqueous mediums, and turbulent mixing methods will necessitate minor adjustments to the variables herein disclosed.

### Test Methods

Ash Analysis is used to quantify the contaminant level, which is of most concern to downstream polymer processing. The method is described below:
a) Accurately weigh about 10-25 mg of a sample and place it into a preconditioned platinum crucible.
b) Moisten the sample with concentrated sulfuric acid (98%), where the amount of sulfuric acid is enough to cover the sample (usually 1 to 3 drops).
c) Using a hot plate heat the sample gently to about 350+/−50° C. until the sample is charred. Slowly heat the sample to ensure no material is lost due to overheating.
d) Heat the residue to about 600-900° C. until all organic material has been burned off.
e) Take the sample out and allow it to cool to room temperature in a dessicator with silica gel.
f) Weigh the residue.
g) Repeat the steps d) to f) until the residue attains a constant weight.
h) Calculate the percent ash as follows: % ash=(final residue weight)×100/(initial sample weight)

Pack Filter life: Melt spinning machines have one or more spin packs which contain filter medium and spinneret. Filter medium normally blinds over time due to contaminants in the melt and the pressure above the filter medium rises as a result. Pack filter life is time it takes a new pack to reach maximum allowable pressure when it requires to be replaced.

Saleable Yield: Weight percent of the polymer extruded that is converted to saleable yarn meeting all product quality criteria

Total Breaks per ton: Number of spinning process interruptions per ton of yarn wound on the bobbins

### Example 1

### Grinding

Three (3) grams of carpet fiber was shorn from post consumer carpet and placed in the jar of a coffee grinder (Sunbeam® Blender/Coffee Mill Model 2774). The cap was closed and the jar locked into the motor base. The grinder automatically turns on at this point and was let run for approximately 1 minute. The grinder was shut off after 1 minute and the fiber removed.

### Example 2

### Turbulent High Shear Mixing with Water

Three (3) grams of carpet fiber was shorn from post consumer carpet and placed in the jar of a coffee grinder (Sunbeam® Blender/Coffee Mill Model 2774) along with 200 ml of deionized water. The cap was closed and the jar was shaken by hand to moisten the fiber with the medium. The jar was then locked into the motor base. The grinder automatically turns on at this point and was let run for approximately 1 minute. The grinder was shut off after 1 minute and the excess water poured off. The fiber was filtered over a 50×50 mesh screen to remove the rest of the water and the fiber allowed to air-dry.

The average results of testing three samples from each Experiment are provided below in Table 1.

TABLE 1
(Ash content data)

| | | 1 Standard |
|---|---|---|
| | Average | Deviation |
| Fiber as received | 0.65% | ±0.16% |
| Example 1 | 0.34% | ±0.22% |
| Example 2 | 0.15% | ±0.05% |

Examples 1 and 2 show a 56% average decrease in ash content between mechanical grinding and one aspect of the disclosed process.

### Example 3

### No Cleaning

Nylon-6,6 recycle fiber shaved from post-consumer carpet was tested for ash content. Three measurements came out to be 0.56%, 0.40%, and 0.60%. The post-consumer fiber was blended with post industrial nylon-66 fiber in 10 to 90 ratio and pelletized using a single-screw extruder. During pelletization, the material was melt-filtered through 325 mesh screen. 25% of the recycled pellet blend was co-extruded with virgin polymer and colorants and spun into pigmented bulked continuous fiber using conventional BCF spinning machine.

### Example 4

### Cleaning Using Commercial Pulper

Post consumer Nylon-66 recycle fiber from used carpets (same source as in Example 3) was cleaned using the following process: Approximately 250 pounds of debaled carpet fiber bundles were added to a 2000 gallon vessel and diluted to approximately 1.5% by weight carpet fiber with water. Turbulent mixing using a 36 inch diameter rotor Tornado 300 H.P. motor run for 15 minutes with full tank exchange every minute was used to separate the carpet fiber bundles into carpet fiber filaments. The pulper was running at 430 RPM with a 0.01 inch rotor-stator gap, which resulted in a nominal shear rate of 81,000 sec⁻¹ and a rotor tip speed of 20.6 m/sec. The separation also removed the entrained particulates and soluble materials from the carpet fiber filaments. The slurry was then provided to a 6000 gallon holding tank and diluted to approximately 0.5% by weight carpet filaments per water. One quart of anti-foam was also added under mild agitation. The slurry then entered a hydrocyclone to remove heavy particulates running at 150 gallons-per-minute. The carpet filaments were then dewatered using an incline screw dewatering device and dried. The dried carpet filaments had the following ash content: 0.32%, <0.1%, <0.1%.

Once dried, the cleaned filaments were blended with post industrial nylon-6,6 fiber in 10 to 90 ratio and pelletized using a single-screw extruder same way as in Example 3. During pelletization, the material was melt-filtered through 325 mesh screen. 25% of the recycled pellet blend was co-extruded with virgin polymer and colorants and spun into pigmented bulked continuous fiber using conventional BCF spinning machine.

### Example 5

### Turbulent Mixing Verses Machine Washing of Post Consumer Carpet Fiber

Six samples of post consumer Nylon-66 recycle fiber from used carpets were cleaned as follows: Samples 1-3 were processed using the pulper and process in Example 4 and Samples 4-6 were cleaned using a commercial top loading washing machine at high agitation in a Merpol® HCS solution. The ash content of the samples is reported in Table 2.

TABLE 2
(Ash content of the samples in Example 5)

| | Average Ash | |
|---|---|---|
| | Content before | Ash Content |
| Sample No. | cleaning | after cleaning |
| 1 | 0.76% ± 0.16 | 0.20% |
| 2 | 0.76% ± 0.16 | <0.1% |
| 3 | 0.76% ± 0.16 | <0.1% |
| 4 | 0.76% ± 0.16 | 0.15% |
| 5 | 0.76% ± 0.16 | 0.26% |
| 6 | 0.76% ± 0.16 | 0.42% |

As shown in Table 2, the ash content of the turbulently mixed carpet fibers are lower than the ash content of the machine washed carpet fibers. Specifically, the average of the turbulently mixed carpet fibers is 0.13% and the average of the machine washed carpet fibers is 0.28%. Furthermore, turbulent mixing results in more consistent ash contents. Here, the standard deviation of the turbulently mixed carpet fibers is 0.06% and the standard deviation of the machine washed carpet fibers is 0.14%. Cleaned carpet fibers with lower and more consistent ash contents are more readily processable and result in superior recycled carpet fiber. (See Example 6 below).

### Example 6

### Spinning Performance of Recycled Carpet Using the Processes Described in Examples 3 and 4

TABLE 3
(Spinning performance data)

| | | | Total | |
|---|---|---|---|---|
| | Recycle | Saleable | Breaks | |
| Example | content | Yield | per ton | Pack Filter Life |
| 3 | 25% | 81.2% | 5.7 | Approx. 1 day |
| 4 | 25% | 85.9% | 2.71 | Approx. 4 days |

Table 3 shows that carpet fiber made with 25% recycled carpet filaments, which were cleaned using one aspect of the disclosed process, results in a more robust and stable carpet yarn pack than carpet fiber made with un-cleaned recycled carpet filaments. The superior results can be attributed to the removal of the particulates and soluble materials from the carpet yarn bundles.

The invention has been described above with reference to the various aspects of the disclosed fiber filament cleaning process, recovery process, carpet fiber recycling process, and carpet yarns made from recycled filaments using the disclosed processes. Obvious modifications and alterations will occur to others upon reading and understanding the proceeding detailed description. It is intended that the invention be construed as including all such modifications and alterations insofar as they come within the scope of the claims.

1. A process for cleaning and recovering carpet fiber filaments having entrained particulate matter comprising:
providing said carpet fiber filaments to a vessel;
separating entrained particulates and soluble materials from said carpet fiber filaments by turbulent mixing in an aqueous medium; and
recovering said carpet fiber filaments from said aqueous medium, whereby said aqueous medium contains a substantial majority of the particulates and soluble materials.

2. The process of claim 1, wherein said turbulent mixing results in a nominal shear rate of about 40,000 sec⁻¹ to about 120,000 sec⁻¹.

3. The process of claim 1 further comprising:
hydrocycloning said carpet fiber filaments to separate heavy particulates from said aqueous medium.

4. The process of claim 1 further comprising:
shearing said carpet fiber filaments away from a carpet backing; and
contacting said sheared carpet fiber filaments with an aqueous medium.

5. The process of claim 1 further comprising:
cleaning and recycling said aqueous medium back into said vessel.

6. The process of claim 1, wherein said process for cleaning does not include mechanical screening or grinding to remove particulates.

7. The process of claim 1, wherein said carpet fiber filaments are thermoplastic polymers.

8. The process of claim 7, wherein said thermoplastic polymers are selected from the group consisting of: nylon, polyester, acrylics, and polyolefin.

9. The process of claim 1, wherein said aqueous medium is selected from the group consisting of: water, deionized water, polar solvents, non-polar solvents, and surfactants.

10. The process of claim 9, wherein said aqueous medium is water.

11. The process of claim 1, wherein said turbulent mixing is achieved using a homogenizer, high shear mixer, jet mixer, or blender.

12. The process of claim 1, wherein said turbulent mixing is achieved using a paper pulper.

13. The process of claim 12, wherein said paper pulper produces a nominal shear rate from about 40,000 sec⁻¹ to about 120,000 sec⁻¹.

14. The process of claim 1, wherein said recovering is conducted using a filter, screen, inclined screw, decanter, centrifuge, press, or a moving belt.

15. The process of claim 1, wherein said recovering is conducting using an inclined screw.

16. The process of claim 1, wherein said recovering is conducted using a decanter centrifuge.

17. The process of claim 1, wherein said recovering is conducted using a moving belt.

18. A process for the cleaning and recovering carpet fiber filaments comprising:
separating entrained particulates and soluble materials from said carpet fiber filaments by turbulent mixing in an aqueous medium;
hydrocycloning said carpet fiber filaments to separate heavy particulates from said aqueous medium;
recovering said carpet fiber filaments from said aqueous medium, whereby said aqueous medium contains a substantial majority of the particulates and soluble materials; and
substantially drying the carpet fiber filaments.

19. The process of claim 18, wherein said turbulent mixing results in a nominal shear rate of from about 40,000 sec⁻¹ to about 120,000 sec⁻¹.

20. A process for the cleaning, recovering, and recycling carpet fiber filaments comprising:
separating entrained particulates and soluble materials from said carpet fiber filaments by turbulent mixing in an aqueous medium;
hydrocycloning said carpet fiber filaments to separate heavy particulates from said aqueous medium;
recovering said carpet fiber filaments from said aqueous medium, whereby said aqueous medium contains a substantial majority of the particulates and soluble materials;
substantially drying the carpet fiber filaments; and
reclaiming the carpet fiber filaments.

21. The process of claim 20, wherein said turbulent mixing results in a nominal shear rate of from about 40,000 sec⁻¹ to about 120,000 sec⁻¹.

22. The process of claim 20, wherein said reclaimed carpet fiber filaments have an ash content of less than about 0.3%.

23. The process of claim 20, wherein said reclaiming further comprises:
granulating or pelletizing said carpet fiber filaments into granules or pellets.

24. The process of claim 22, further comprising melt extruding said reclaimed carpet fiber filaments.

25. The process of claim 23, further comprising melt extruding said granules or pellets.

26. A thermoplastic material made from the granules or pellets of claim 25.

27. A carpet fiber made from the granules or pellets of claim 25.

28. A thermoplastic pellet or granule comprising:
between 5% and 100% by weight post-consumer carpet yarn filaments that are substantially free of particulates and soluble materials, wherein said post-consumer carpet yarn filaments were subject to high-shear mixing; and up to 95% of a material selected from the group consisting of: post-industrial thermoplastic filaments, post-consumer thermoplastic filaments, virgin thermoplastic, and recycled PET.

29. The thermoplastic pellet or granule of claim 28, wherein said post-consumer carpet yarn filaments have an ash content of less than about 0.3% prior to processing.

30. A carpet fiber made from the thermoplastic pellet or granule of claim 28.

31. A carpet made from the carpet fiber of claim 30.

32. A carpet fiber comprising:
between 2.5% and 95% by weight recycled carpet fiber, wherein said recycled carpet fiber comprises carpet filaments that are substantially free of particulates and soluble materials and were subject to high-shear mixing; and
between 97.5% and 5% by weight of a material selected from the group consisting of: post industrial thermoplastic filaments, post consumer thermoplastic filaments, virgin thermoplastic, and recycled PET.

33. The carpet fiber of claim 32, wherein said carpet filaments have an ash content of less than about 0.3%.

34. A carpet made from the carpet fiber of claim 32.
